(19) United States
(12) Patent Application Publication
(10) Pub. No.: US 2002/0083400 A1
(43) Pub. Date: Jun. 27, 2002

(54) Method and apparatus for generating package geometries

(76) Inventors: Liau Hon Chung, Singapore (SG); Tan Mei Ling, Singapore (SG); Hon Wui Chung, Singapore (SG); New Thiam Peng, Singapore (SG); James Feezor, Payson, AZ (US)

Correspondence Address: KLARQUIST SPARKMAN, LLP, One World Trade Center, Suite 1600, 121 S. W. Salmon Street, Portland, OR, 97204, US

(21) Appl. No.: 10/013,889

(22) Filed: Dec. 7, 2001

Related U.S. Application Data
(63) Continuation of application No. 09/192,177, filed on Oct. 30, 1998.
(60) Provisional application No. 60/063,877, filed on Oct. 31, 1997.

(51) Int. Cl. G06F 17/50

(52) U.S. Cl. 716/3; 716/18

(57) ABSTRACT

Geometry for component packages are generated by reading from computer memory a package data file that provides physical dimension information for a component package; determining which of a number of rulesets applies to the package data file; and generating a geometry for the component package by applying rules of an applicable ruleset to the package data file. The method may further include determining which of a number of site parameters and/or board technology parameters applies to the package data file; and generating a geometry for the component package by applying rules of an applicable ruleset to the applicable site and/or board technology parameters.

### RELATED APPLICATION DATA

This application is a Continuation of U.S. patent application Ser. No. 09/192,177, filed Oct. 30, 1998. This application also claims priority to Provisional Application No. 60/063,877 filed Oct. 31, 1997.

### FIELD OF THE INVENTION

This invention relates generally to CAE (computer-aided engineering) or EDA (electronic design automation) tools. These tools are computer programs that execute on a computer for designing electronic and other types of devices. More particularly, this invention relates to improving and simplifying the generation of footprints for components that are mounted on printed circuit boards (PCBs). A component's footprint defines the board area required for a component's package and is used by a CAE tool in the process of placing components on a particular printed circuit board.

### BACKGROUND OF THE INVENTION

CAE tools are widely used today in computers to design electronic devices. One tool of particular value is the PCB design tool, which enables a circuit engineer to simulate a printed circuit board before its construction. As part of the simulation the tool places desired components on a board and then automatically connects them in a preferred manner. The simulated board can then be tested for thermal and other characteristics. Once the simulated board has satisfied all design requirements, a computer file representing the board is used for the actual board construction. For example, typically a PCB tool provides an output file that is used as input to control the operation of computerized circuit board assembly machines at one or more manufacturing sites.

Each component mounted on a circuit board has a footprint, defined as the board area required for mounting the component's package. The footprint is determined by the land patterns required by the package, which are the board areas under the component's pins. A component with 40 pins to be soldered to a PCB, for example, has 40 land patterns on the board. FIG. 1 shows a typical geometry for a PLCC (plastic leadless chip carrier). The pins of the carrier contact the circuit board in the rectangular areas known as land patterns. The size, shape, and spacing of these land patterns is a function of a number of factors such as component data sheet information, the nature of the manufacturing site, component specifications, board type, etc.

Typically these footprints are manually determined by the expertise of persons known as component librarians, often with quite a bit of trial and error, and are then made available to circuit designers through a component library. FIG. 2 show how the conventional, manual approach works.

The drawbacks of the conventional approach are several. First, there is no assurance that the librarian will take into account all factors that affect the component's geometry. Second, because the approach is individual, the librarian has only his or her expertise to rely on and can easily make errors. Third, the approach is slow, often requiring days or weeks between the request for a component geometry and its generation. Fourth, the approach is often duplicative, with several librarians generating the similar component geometries for different manufacturing sites.

An objective of the invention, therefore, is to provide a method and means for simplifying and improving the process for generating component package geometries.

### SUMMARY OF THE INVENTION

A computer-implemented method for generating a component geometry includes reading from computer memory a package data file that provides physical dimension information for a component package; determining which of a number of rulesets applies to the package data file; and generating a geometry for the component package by applying rules of an applicable ruleset to the package data file. The method may further include determining which of a number of site parameters and/or board technology parameters applies to the package data file; and generating a geometry for the component package by applying rules of an applicable ruleset to the applicable site and/or board technology parameters.

Other aspects of the invention are described in the following description of an illustrative embodiment and illustrated in the accompanying drawings.

### BRIEF DESCRIPTION OF THE DRAWINGS

FIG. 1 a drawing a component package and its component geometry.

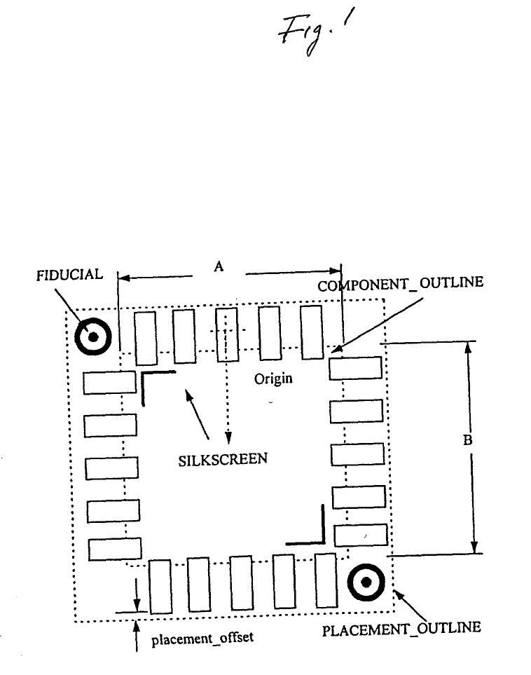

FIG. 2 is a flow diagram of a conventional approach to generating component geometries.

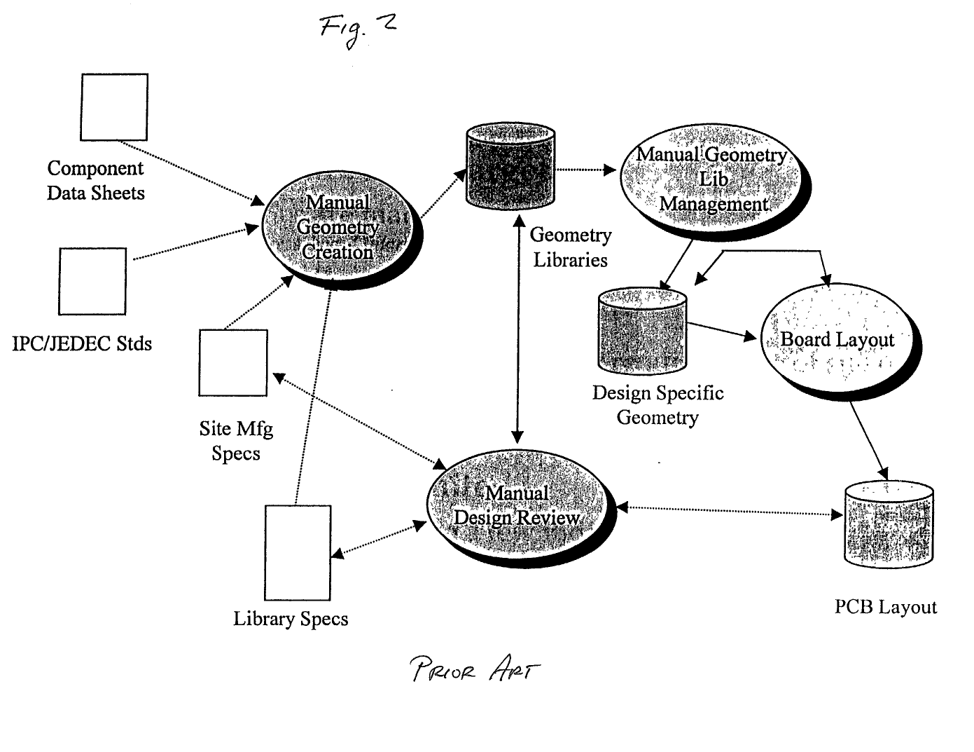

FIG. 3 is a block diagram of an exemplary computing environment for executing an application in accordance with the invention.

FIG. 4 is a block diagram of a process for generating component geometries in accordance with the invention.

FIG. 5 is an example of such component geometry image generated in accordance with the invention.

FIG. 6 is a diagram of the hierarchy information data examined in the process of generating component geometries in accordance with the invention.

FIG. 7 is a diagram of the organization of manufacturing sites parameters by site and line.

FIG. 8 is a diagram of the organization of board technology parameters by board type.

FIG. 9 is a diagram of the organization of rules by rule set and rules within each rule set.

FIG. 10 is a flowchart of a method for generating component geometries in accordance with the invention.

FIG. 11 is a drawing a component package and its geometry generated in accordance with the invention.

### DETAILED DESCRIPTION OF AN ILLUSTRATIVE EMBODIMENT

The invention is presently implemented in a computer program (also referred to as an application or application program) that is stored on a computer-readable medium and executes on a digital computer.

An Exemplary Computing Environment

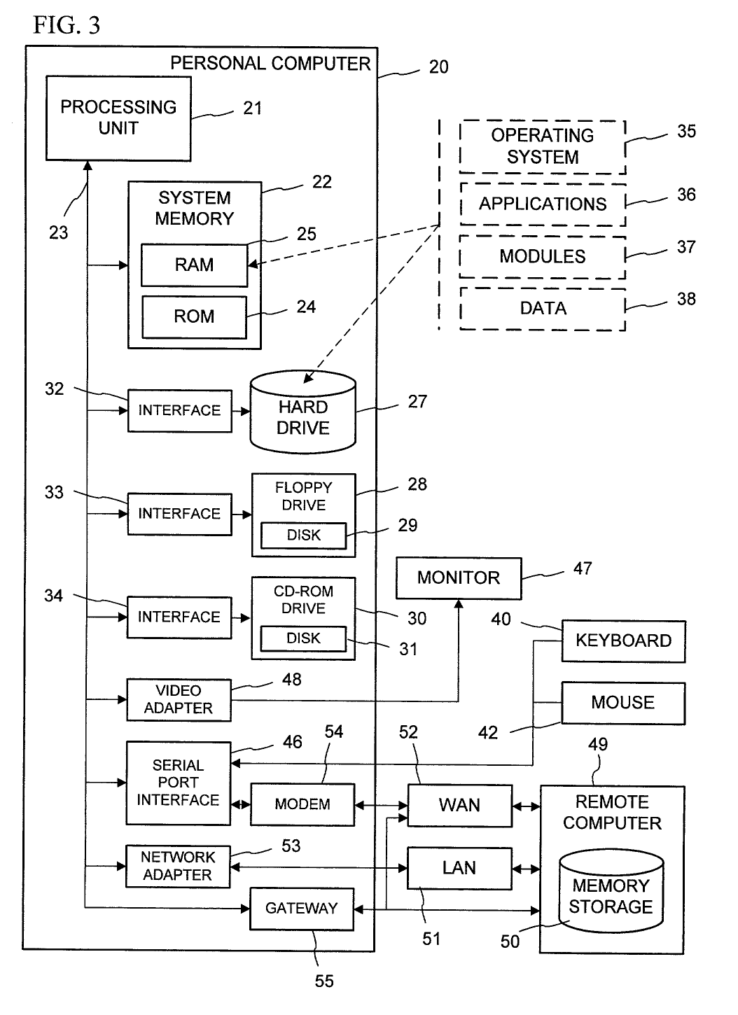

FIG. 3 and the related description are intended to provide a brief, general description of a suitable computing environment in which the invention may be implemented. While the invention will be described in the general context of computer-executable instructions of a computer program that runs on a computer, those skilled in the art will recognize that the invention also may be implemented in combination with other program modules. Generally, program modules include routines, programs, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The illustrated embodiment of the invention also is practiced in distributed computing environments where tasks are performed by remote processing devices that are linked through a communications network. But, some embodiments of the invention can be practiced on stand-alone computers. In a distributed computing environment, program modules may be located in both local and remote memory storage devices.

With reference to FIG. 3, an exemplary system for implementing the invention includes a computer 20, including a processing unit 21, a system memory 22, and a system bus 23 that couples various system components including the system memory to the processing unit 21. The processing unit may be any of various commercially available processors, such as Intel x86, Pentium and compatible microprocessors from Intel and others, the Alpha processor by Digital, and the PowerPC from IBM and Motorola. Dual microprocessors and other multi-processor architectures also can be used as the processing unit 21.

The system bus may be any of several types of bus structure including a memory bus or memory controller, a peripheral bus, and a local bus using any of a variety of conventional bus architectures such as PCI, AGP, VESA, Microchannel, ISA and EISA, to name a few. The system memory includes read only memory (ROM) 24 and random access memory (RAM) 25. A basic input/output system (BIOS), containing the basic routines that help to transfer information between elements within the computer 20, such as during start-up, is stored in ROM 24.

The computer 20 further includes a hard disk drive 27, a magnetic disk drive 28, e.g., to read from or write to a removable disk 29, and an optical disk drive 30, e.g., for reading a CD-ROM disk 31 or to read from or write to other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide nonvolatile storage of data, data structures, computer-executable instructions, etc. for the computer 20. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment.

A number of program modules may be stored in the drives and RAM 25, including an operating system 35, one or more application programs (e.g. the illustrative embodiment) 36, other program modules 37, and program data 38.

A user may enter commands and information into the computer 20 through a keyboard 40 and pointing device, such as a mouse 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB). A computer monitor 47 or other type of display device is also connected to the system bus 23 via an interface, such as a video adapter 48. In addition to the monitor, personal computers typically include other peripheral output devices (not shown), such as speakers and printers.

The computer 20 is expected to operate in a networked environment using logical connections to one or more remote computers, such as a remote computer 49. The remote computer 49 may be a web server, a router, a peer device or other common network node, and typically includes many or all of the elements described relative to the computer 20, although only a memory storage device 50 has been illustrated in FIG. 3. The computer 20 can contact the remote computer 49 over an Internet connection established through a gateway 55 (e.g., a router, dedicated-line, or other network link), a modem 54 link, or by an intra-office local area network (LAN) 51 or wide area network (WAN) 52. It will be appreciated that the network connections shown are exemplary and other means of establishing a communications link between the computers may be used.

In accordance with the practices of persons skilled in the art of computer programming, the present invention is described below with reference to acts and symbolic representations of operations that are performed by the computer 20, unless indicated otherwise. Such acts and operations are sometimes referred to as being computer-executed. It will be appreciated that the acts and symbolically represented operations include the manipulation by the processing unit 21 of electrical signals representing data bits which causes a resulting transformation or reduction of the electrical signal representation, and the maintenance of data bits at memory locations in the memory system (including the system memory 22, hard drive 27, floppy disks 29, and CD-ROM 31) to thereby reconfigure or otherwise alter the computer system's operation, as well as other processing of signals. The memory locations where data bits are maintained are physical locations that have particular electrical, magnetic, or optical properties corresponding to the data bits.

Overview

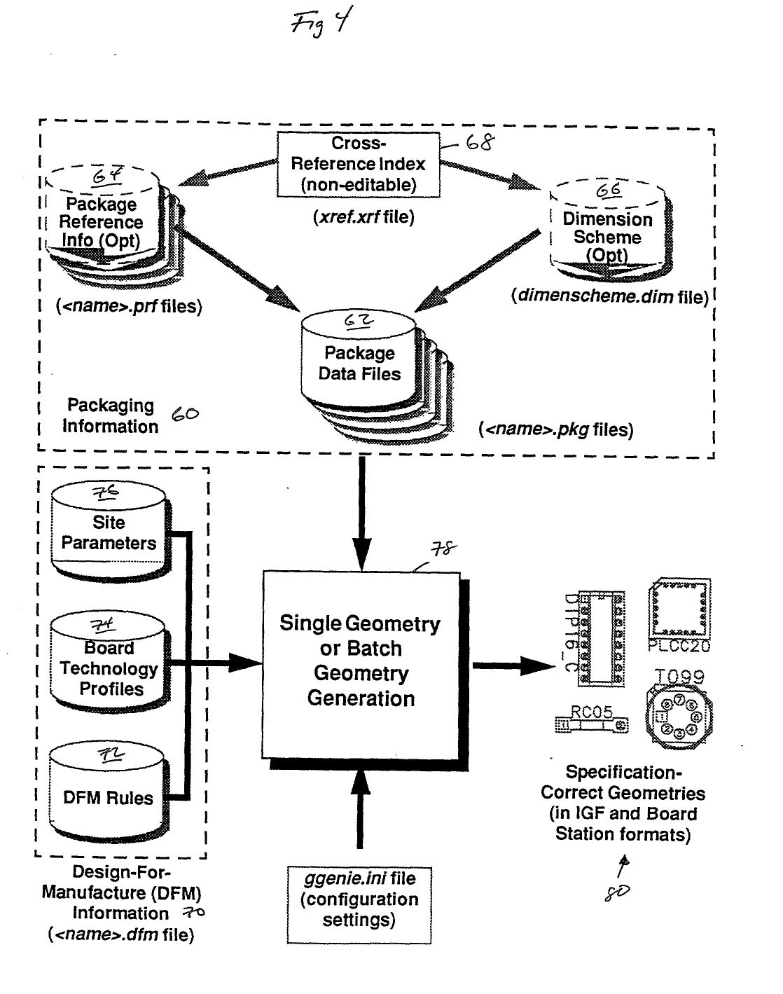

FIG. 4 is a block diagram of a process for generating component geometries in accordance with the invention. Packaging information 60 for various components is contained in a library of package data files 62. A package data file 62 provides physical dimension information for a particular type of component package. Typical information includes the package type, units of measure, pin count, and pin pitch. Other information might include geometry attribute and values for such items as the body width, body height, body diameter, silkscreen diameter, etc. Preferably the dimension information is independent of where the geometry is manufactured or of the board technology used; this manufacturing process information normally resides in other files to be described.

Information in a package data file might be entered by a user and thus reside in the package data file itself, or it might be included from a reference source. One such source is package reference files 64 each which includes reference information for packages such as is found in IPC and JEDEC standards. (The IPC and JEDEC are organizations that set standards for design of component geometries.) Including referenced information in a package data file 62 is optional.

A package reference file 64 is associated with a package data file 62 through a dimension scheme file 66, which itself is associated with the same package data file. The dimension scheme, if invoked for a package data file with a specified pin count and pin pitch, provides a package reference type and a package reference file name through a cross-reference file 68. The cross-reference file defines the relationship between package types, the dimension scheme associated with the package data file, and a particular package reference file.

To generate a geometry, a package data file 62 (which may contain the optional reference information) for a component is selected by a user. Combined with information from the selected data file is information from manufacturing information file 70, which at a minimum includes a number of rulesets 72 that generate geometries from the selected information in the selected data file. The manufacturing information may also include site parameters 74 for particular manufacturing sites and board technology parameters 76 for different types of boards on which the component package may be placed. In response to a command from the user, a geometry generator 78 reads from computer memory the selected package data, determines which of the number of rulesets 72 applies to the package data file; and, generating a geometry for the component package by applying rules of an applicable ruleset to the package data file. If site parameters 74 are included in the geometry generation, then the generator 78 determines which of the number of site parameters applies to the selected package data file and generates a geometry by also applying rules of the applicable ruleset to the applicable site parameters. Similarly, if board technology parameters 76 are included in the geometry generation, then the generator 78 determines which of the number of parameters 78 applies to the selected package data file and generates a geometry by also applying rules of the applicable ruleset to the applicable board technology parameters.

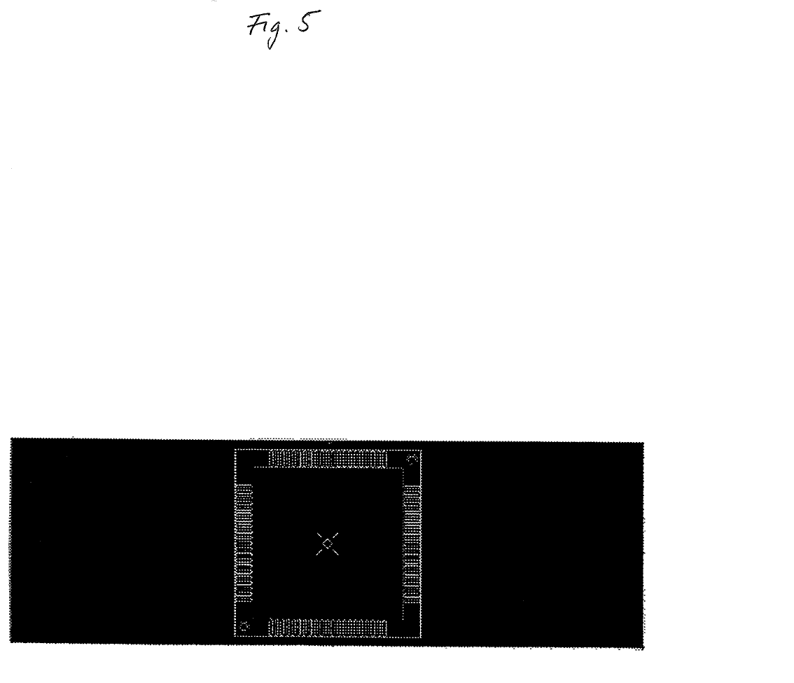

The generator 78, as a result of the geometry generation, produces an output data file 80 suitable as input to a CAE tool such as a PCB layout tool. As shown in FIG. 4, the output data file provides specification-correct geometries in a number of formats such as a neutral format (i.e., IGF) or a proprietary format (i.e., Board Station). The generator also provides an output data file that generates an image of the component geometry on monitor 47 for immediate feedback to the user. FIG. 5 is an example of such an image for a PLCC.

The Package Data File

As noted above, the package data file provides physical dimension information for different types of packages. When a user (librarian, manufacturing engineer or layout engineer, for example) sets up a package data file, he not only creates attributes unique for that package, but he might also dynamically include information found in an associated dimension scheme file 66 or package reference file 64.

The dimension scheme file defines a standard set of dimensioning attributes for each package of a certain type and pin count, and provides a way to include those dimensions into a package data file. Specifically, the dimension scheme file describes different package types such as PLCC or SOP (small outline package) and the dimensions allowed for a given package type and an association between such package types and a package dimension scheme file. Table 1 is an example of a typical dimension scheme file. The rows within the dimension scheme file each refer to a different dimension scheme that might be applied to a package data file, distinguished by package type and pin count.

The information in a package dimension scheme in file 66 includes a series of package attributes and an assigned variable name. A dimension scheme may also include attributes that are calculated from reference attributes. These calculated attributes might be used, for example, to determine dimensions not provided directly in a package data file or associated package reference file. Table 2 is an example of the contents of a package dimension scheme.

A package reference file 64 lists reference attributes and their values for a geometry with a certain package type, pin pitch, and pin count. The dimensions from the reference file can then be dynamically included into a package data file. Included dimensions differ from other dimensions that might appear in the package data by providing an exact numeric or string value for a given dimension. The package data file dynamically loads the values of included dimensions whenever a package data file is opened before generating a geometry. Table 3 is an example of the contents of a package reference file.

The cross-reference file 68 defines the relationship between package types, the dimension scheme associated with the package data file, and a particular package reference file. Table 4 shows the contents of a typical cross-reference file. Each line refers to an association between a package reference file, a reference type, and a package type.

The Manufacturing Information File

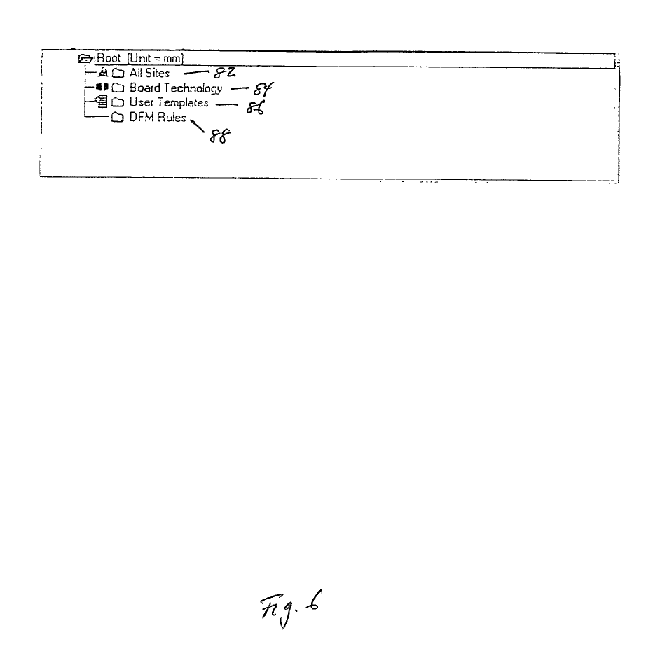

As shown in FIG. 6, the manufacturing file 70 is organized as a hierarchy of directories whose contents are examined by the generator 78 in the process of generating a component geometry. The top level of the hierarchy (directory or folder 82) contains manufacturing site parameters 76. The next level of the hierarchy (folder 84) contains board technology parameters 74. The third level of the hierarchy (folder 86) contains user templates. And the bottom level of the directory (folder 88) contains rules organized into rulesets.

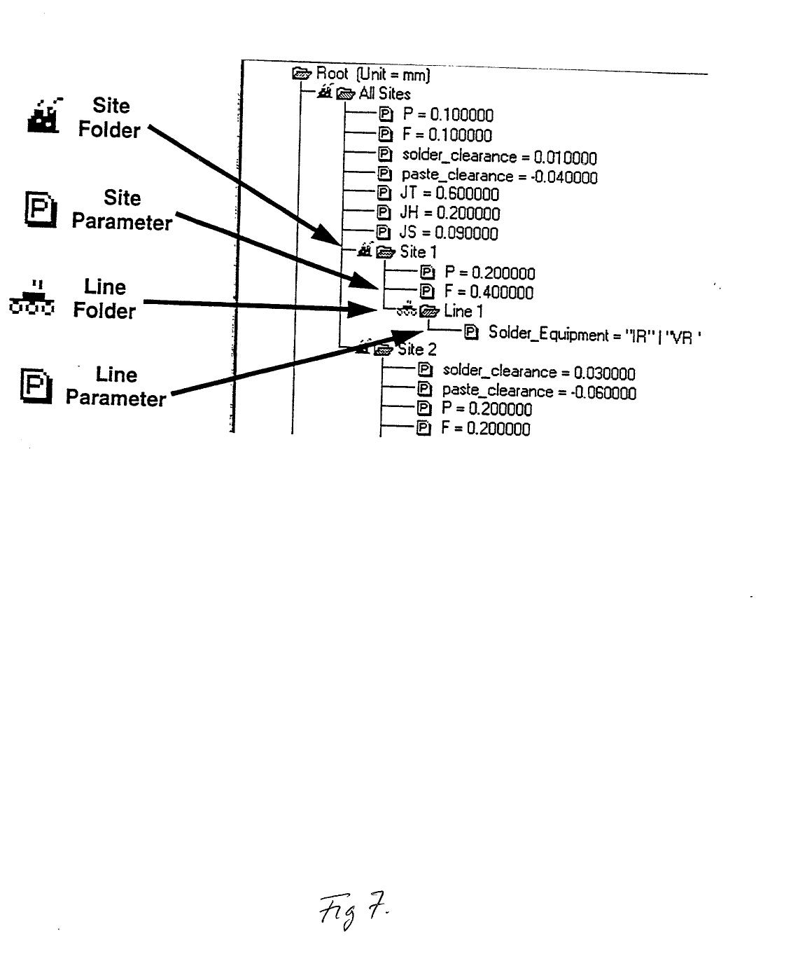

The sites folder 82 contains the names of individual manufacturing sites and, if applicable, the name of manufacturing lines within those sites. Manufacturing sites and lines within sites are symbolized by folders; with the folders are site or line parameters which define the conditions needed to generate a geometry specific to that manufacturing site or line. An example of a site parameter is a board fabrication error used in the determination of land pattern dimensions. An example of a line parameter is a list of available soldering equipment at the site or line. FIG. 7 shows an example of an expanded sites folder 82. The parameters listed therein include part placement tolerance (P), printed board fabrication tolerance (F), solder fillet at the toe (JT), solder fillet at the heel (JH), and solder fillet at the side (JS). Other parameters include solder process (infrared, wave solder, vapor reflow, etc.), board sizes, supported board technology, top height restriction, and bottom height restriction.

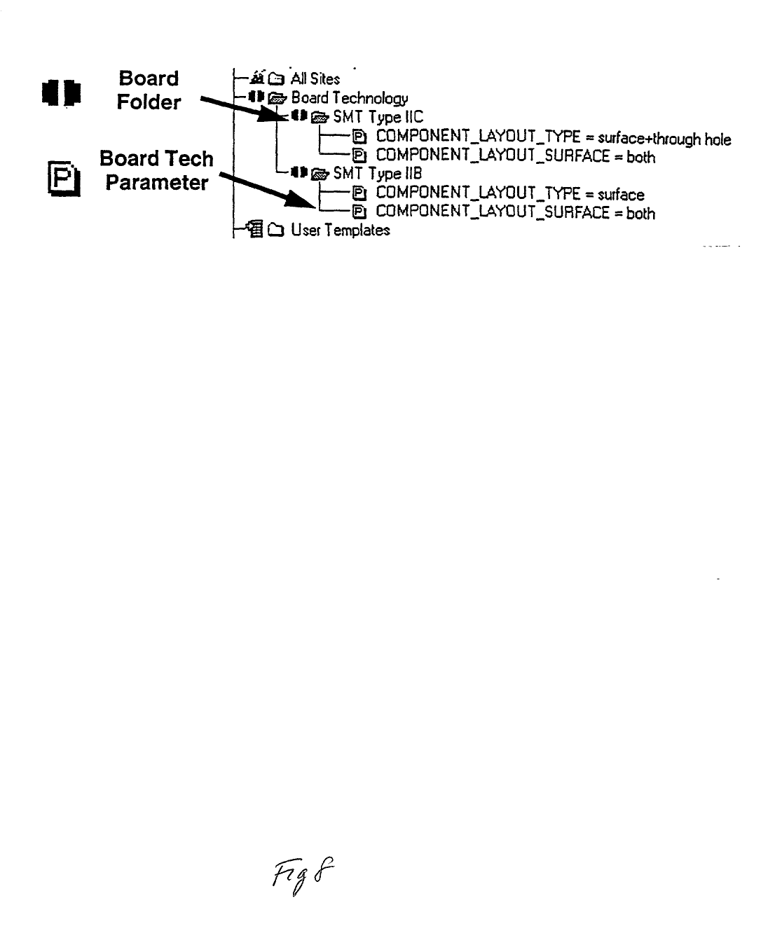

The board technology folder 84 contains the names of different types of board technologies that might be used when manufacturing a circuit board. As shown in FIG. 8, board technologies are represented within folder 84 as folders. Within these folders are parameters that define conditions needed to generate a geometry specific to that board technology. Table 5 shows examples of board technologies and their parameters classified according to the IPC board type classification categories. A type 1 circuit board has components mounted on only one side of the board; a type 2 circuit board permits components to be mounted on both sides. Each board type is further divided into A, B, or C categories according to the mounting technology. An A category consists of through-hole mounting technologies requiring simply assembly techniques. A B category consists of surface mounting technologies requiring moderately complex assembly techniques. A C category intermixes through-hole and surface mounting technologies on the same board surface, resulting in very complex assembly techniques. Other board classification schemes are possible, such as by the rigidity of the board.

The user template folder 86 defines custom manufacturing rules such as design-for-manufacturing (DFM) rules to create graphics or leads (pins) not covered by rules supplied with the application.

The rules folder 88 has several rulesets and, within those rulesets, other rulesets or individual rules. Together, the rules and rulesets form a hierarchical database of rules to apply when creating a specific type of geometry. Rules perform the following functions. They specify the defaults and constants to use in the calculation of geometry dimensions. They specify the different categories of geometry according to package type, fine pitch versus normal requirements, soldering requirements, etc. And they specify the graphics and attributes of each type of geometry.

Rules can be of a number of types, such as evaluation rules and template rules. Evaluation rules describe how to determine the value of an attribute using a mathematical equation. For example, the following are evaluation rules:

silkscreen_clearance=>0.5

Solder_Mask_Setback=1.0

Placement_Outline_x=package_body_x+pad_length_x.

In the first example, the evaluation rule specifies that the silkscreen clearance must be greater than or equal to 0.5. The second example assigns a specific value of 1.0 to the named attribute. In the third example, the evaluation rule derives the value of Placement_Outline_x from the values of package_body_x and pad_length_x, found in the applicable package data file.

Template rules specify naming and drawing defaults, create objects of different shapes, create lead (pin) frames, or group objects together. Template rules that create objects or lead frames render those objects based on the calculation of variable values found in the applicable package data file.

Rulesets can also be of a number of types, including single-execution conditional rulesets and multiple-execution “for” rulesets. Single execution rulesets have a value of “if”, “else if”, “else”, or “no condition”. These rulesets, which are evaluated sequentially within the rules folder 88, only apply if their condition is met. For each instance of the condition, the rules within the ruleset are applied only once. Non-conditional rulesets usually occur at the top of a rules hierarchy and contain rules that apply to all geometries.

Multiple-execution “for” rulesets repeat or “loop” the rules within the ruleset a specified number of times. Like single-condition rulesets, one or more conditions can be specified that trigger the for loop associated with the “for” ruleset. Unlike the single-conditional rulesets, however, once the qualifying condition is met the application applies the rules within the ruleset several times until the loop count is complete.

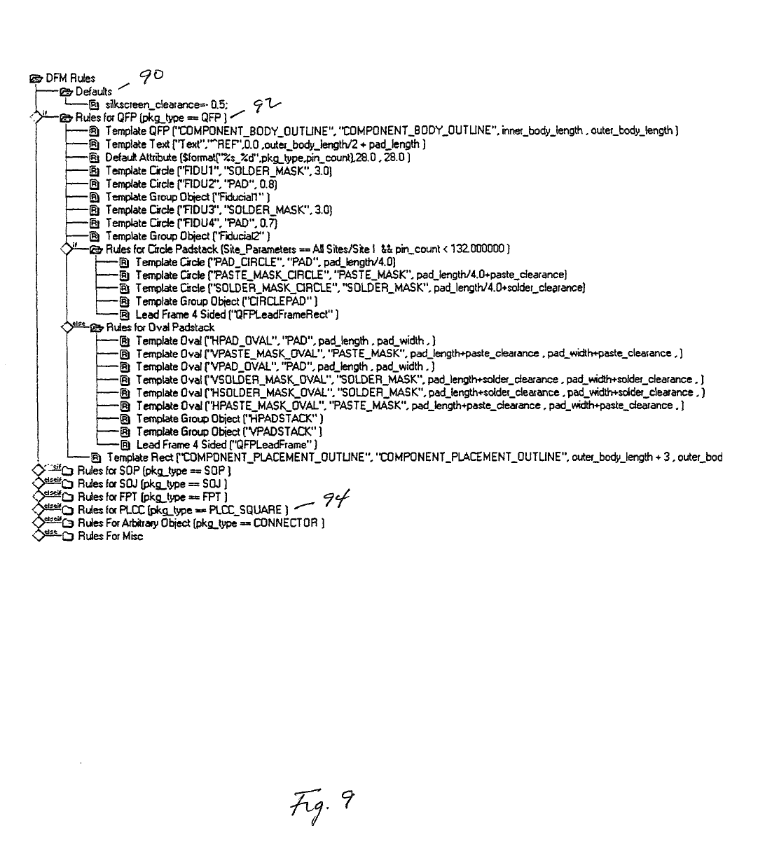

FIG. 9 shows the rules folder 88 with a default ruleset 90 and a ruleset 92 for a quad flat pack (QFP) package expanded so that the individual rules therein are visible. Following each ruleset, within each parenthesis are the conditions under which that ruleset applies. The ruleset 92, for example, applies only when the pkg_type attribute value from a package data file being evaluated equals QFP. This ruleset is thus selected only for QFP packages. Contrast ruleset 92 with ruleset 94, which applies only if the package data file being evaluated is a PLCC package.

Rulesets can be nested within one another. For example, ruleset 92 may have contained within it other rulesets that apply further conditions to the PLCC package, such as a nest ruleset requiring the presence of a specific attribute J:

Rules for PLCC (pkg_type═PLCC && J property exists)

Within this nested ruleset would be rules specific to that component package.

Generating the Component Geometry

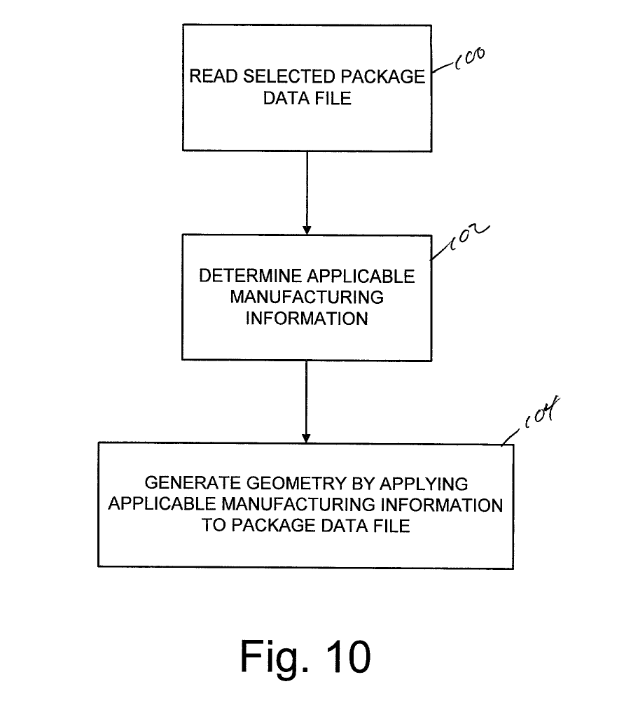

FIG. 10 is a flowchart showing at a high level the method followed by the geometry generator 78 to generate component geometries. As a first step 100, the package data file is read by the application to determine its content. The content may contain reference file and dimension scheme information if the user has invoked an applicable dimension scheme. The application then determines what information in the manufacturing file 70 is applicable to the package data file (step 102). If only rule sets are present, then the application proceeds through the rule sets to find if any applies. If so, it then follows the rules of the applicable rule set(s). If site parameters or board technology parameters are present in the file 70, they are also examined to determine if any are applicable to the package data file. If so, the applicable site parameters and/or board technology parameters are also applied in generating the geometry (step 104).

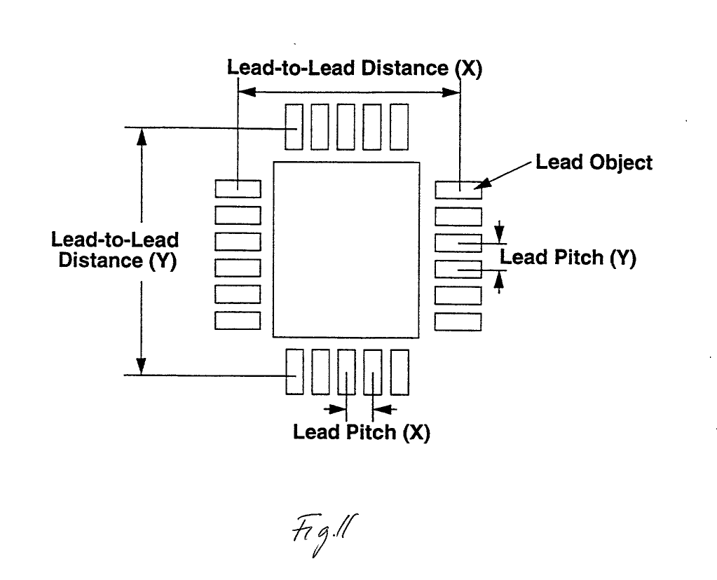

The output of the generation is an output file 80 that is suitable for input to a CAE tool. FIG. 11 shows an image of a component package geometry produced by the application.

Having illustrated and described the principles of the invention in an exemplary embodiment, it should be apparent to those skilled in the art that the illustrative embodiment can be modified in arrangement and detail without departing from such principles. Many of the software aspects of the embodiment may be implemented in hardware and many of the hardware aspects may be implemented in software. In view of the many possible embodiments to which the principles of the invention may be applied, it should be understood that the illustrative embodiment is intended to teach these principles and is not intended to be a limitation on the scope of the invention defined in the following claims. We therefore claim as our invention all that comes within the scope and spirit of these claims and their equivalents.

We claim:

1. A computer-implemented method for generating a component geometry, comprising:
reading from computer memory a package data file that provides physical dimension information for a component package;
determining which of a number of rulesets applies to the package data file; and
generating a geometry for the component package by applying rules of an applicable ruleset to the package data file.

2. The method of claim 1 wherein the generating step comprises generating a data file suitable for input to a CAE tool.

3. The method of claim 1 wherein the generating step comprises generating a data file suitable for viewing on a computer monitor.

4. The method of claim 1 wherein the rulesets are conditional and the determining step comprises examining the conditions of the rulesets to determine which applies to the package data file.

5. The method of claim 1 wherein the reading step comprises reading a package data file selected by a user.

6. A computer-readable medium on which are stored computer instructions for executing the steps of claim 1.

7. The method of claim 1 including:
determining which of a number of site parameters applies to the package data file; and
generating a geometry for the component package by applying rules of an applicable ruleset to the applicable site parameters.

8. The method of claim 7 wherein the determining step comprises reading site parameters selected by a user.

9. The method of claim 1 including:
determining which of a number of board technology parameters applies to the package data file; and
generating a geometry for the component package by applying rules of an applicable ruleset to the applicable board technology parameters.

10. The method of claim 9 wherein the determining step comprises reading board technology parameters selected by a user.

11. A computer-implemented method for generating a component geometry, comprising:
storing in computer memory package data files that provide physical dimension information for component packages;
storing in computer memory manufacturing site parameters that provide information about manufacturing sites;
storing in computer memory printed circuit board technology parameters that provide information about printed circuit board technologies; and
generating a component geometry based on selection of a package data file, manufacturing site parameters, and printed circuit board technology parameters for a component package.

12. The method of claim 11 wherein the generating step comprises:
determining which site parameters applies to the package data file; determining which board technology parameters applies to the package data file;
determining which of a number of rulesets applies to the package data file; and
generating a geometry for the component package by applying rules of an applicable ruleset to the package data file, applicable site parameters, and applicable board technology parameters.

13. A computer-implemented method for constructing a package data file that provides physical dimension information for a component package, comprising:
reading from computer memory the selection of a package data file;
determining from the selection an applicable package reference file that supplies reference attributes for the selected package data file;
determining from the selection applicable calculated attributes; and
associating the reference attributes and calculated attributes with the selected package data file.

14. The method of claim 13 wherein the reading steps comprises reading a package data file selected by a user.

15. The method of claim 13 wherein the first determining step comprises checking a cross-reference file to determine if a package reference file is associated with the selected package data file.

16. A computer-readable medium on what are stored computer instructions for executing the steps of claim 13.

17. An apparatus for generating a component geometry, comprising:
package data files stored in a computer, the package data files providing physical dimension information for component packages;
rulesets stored in the computer, the rulesets containing rules for generating component geometry; and
a processing unit programmed to execute the following steps:
reading from a package data file;
determining which of the rulesets applies to the package data file; and
generating a geometry for the component package by applying rules of an applicable ruleset to the package data file.

18. The apparatus of claim 17 wherein the generating step executed by the processing unit comprises generating a data file suitable for input to a CAE tool.

19. The apparatus of claim 17 including:
site parameters stored in the computer; and
the processing unit programmed to execute the following steps:
determining which of the site parameters applies to the package data file; and
generating a geometry for the component package by applying rules of an applicable ruleset to the applicable site parameters.

20. The apparatus of claim 17 including:
board technology parameters stored in the computer; and
the processing unit programmed to execute the following steps:
determining which of the board technology parameters applies to the package data file; and
generating a geometry for the component package by applying rules of an applicable ruleset to the applicable board technology parameters.
